(19) United States
(12) Patent Application Publication
(10) Pub. No.: US 2020/0127530 A1
(43) Pub. Date: Apr. 23, 2020

(54) ELECTRONIC COMPONENT AND METHOD FOR THE PRODUCTION THEREOF

(71) Applicant: Vitesco Technologies Germany GMBH, Hannover (DE)

(72) Inventors: Uwe Stephan, Schaumburg, IL (US); Marcus Ulherr, Schwarzenbruck (DE)

(73) Assignee: Vitesco Technologies Germany GMBH, Hannover (DE)

(21) Appl. No.: 16/706,077

(22) Filed: Dec. 6, 2019

Related U.S. Application Data
(63) Continuation of application No. PCT/EP2018/064244, filed on May 30, 2018.

(30) Foreign Application Priority Data
Jun. 7, 2017 (DE) 10 2017 209 519.9

(51) Int. Cl. H02K 5/22; H01R 12/71; H01R 13/04; H01R 43/24; H02K 5/08; H02K 15/12; H02K 15/14; B60R 16/03

(52) U.S. Cl. CPC H02K 5/225; H01R 12/716; H01R 13/04; H01R 43/24; F16H 61/0251; H02K 15/12; H02K 15/14; B60R 16/03; H02K 5/08

(57) ABSTRACT

The invention relates to an electrical component (10), in particular for a motor vehicle, comprising an electrical part (14) and an electronic control device (16) which has a contact strip (18), wherein the control device (16) and the electrical part (14), at least in regions, are encapsulated by injection molding with a plastic (32) which mechanically connects the electrical part (14) and the control device (16) and forms a socket (21) around the contact strip (18). The invention also relates to a method of producing an electrical component of this kind.

This application claims the benefit of PCT Application PCT/EP2018/064244, filed May 30, 2018, which claims priority to German Application DE 10 2017 209 519.9, filed Jun. 7, 2017. The disclosures of the above applications are incorporated herein by reference.

The invention relates to an electrical component, in particular for a motor vehicle, and also to a method for the production thereof.

An increasing number of electrical components are being used in modern motor vehicles. Electric motors which serve as actuating motors for further parts of the motor vehicle are particularly important in this respect. For example, actuating motors of this kind are installed in the transmission of motor vehicles where they serve firstly to control the clutch and secondly can be used as gear selectors. In order to make it easier to actuate components of this kind, such components are generally directly connected to electronic control devices which receive abstract control commands for the electrical part via a bus system of the motor vehicle and convert said abstract control commands into the tangible control of the part.

Specifically in the case of actuating motors which are installed in the region of the transmission, the combination of actuating motor and electronic control device has to be able to withstand mechanical and thermal loads which are often high. The electrical part and the control device are therefore usually installed in a housing which protects the electrical part and the control device and, toward the outside, provides a socket for making electrical contact. The control device can receive control signals and also obtain the required operating current for the electrical part via said socket.

Housings composed of plastic, composed of sheet metal or composed of cast aluminum are usually used for this purpose.

Mounting the electrical part and the electronic control unit and also the contact socket into a housing of this kind requires a considerable amount of work which increases the production costs and, owing to the complexity, can additionally lead to incorrect mounting and therefore to rejection.

The object of the present invention is therefore to provide an electrical component and also a method for the production thereof which allow particularly simple assembly of the component.

This object is achieved by an electrical component having the features of patent claim 1 and also by a method having the features of patent claim 8.

An electrical component of this kind, in particular for a motor vehicle, comprises an electrical part and an electronic control device which has a contact strip. Provision is made here for the control device and the electrical part, at least in regions, to be encapsulated by injection molding with a plastic which mechanically connects the electrical part and the control device and forms a socket around the contact strip.

Instead of complex assembly with a large number of working steps, encapsulation by injection molding with the plastic can therefore provide both a mechanically stable housing and also the connection of the electrical part and the electronic control device. At the same time, the desired geometry of the socket around the contact strip is formed during the encapsulation by injection molding, and therefore the provision of an individual component for the socket can be dispensed with. A preassembly step is also dispensed with in this way.

Since a separate component for the socket can be dispensed with, contact points between socket and housing through which media such as water or transmission fluid could enter the housing are also dispensed with. Therefore, a particularly thick and therefore particularly durable component is obtained.

Therefore, an electrical component which can be produced in a particularly quick and simple manner is created overall, as a result of which both the production costs and also the rejection rate can be reduced.

It is preferred here for the contact strip to be a metal contact comb. Said contact comb can be mounted in a particularly simple manner on the electronic control device which can be embodied, for example, as a printed circuit board.

It is further advantageous for the contact strip to have a main body composed of a plastic.

As a result, the contact strip is provided with additional mechanical stability, and therefore deformation during the encapsulation by injection molding can be avoided. In this case, it is also possible for the main body to be incipiently melted during the encapsulation by injection molding and therefore enter into a cohesive connection with the plastic of the encapsulation by injection molding, so that a particularly stable electrical component is created.

In a further preferred embodiment of the invention, the plastic completely encapsulates the control device. Therefore, the sensitive electronic parts of the electronic control device are reliably protected against environmental influences.

It is further preferred for the electrical part of the electrical component to be embodied as an electric motor, in particular as an electric actuating motor for a motor vehicle.

As a result, specifically those parts which are exposed to high mechanical loads during operation of the motor vehicle are particularly simply designed in a reliable and stable manner and therefore protected against the operating loads.

It is further preferred for the socket to be embodied as a socket for a bus system, in particular for a CAN or LIN bus.

This ensures that an electrical component of this kind can be connected to further parts of the motor vehicle in a standardized manner, without adapters or the like being required.

In a further preferred embodiment of the invention, the plastic is a thermoset. Plastics of this kind are both mechanically and also thermally particularly stable.

The invention also relates to a method for producing an electrical component in which a contact strip and an electrical part are preassembled with an electronic control device and inserted into an injection molding die together with said electronic control device. In the injection molding die, said elements, at least in regions, are encapsulated by injection molding with a plastic which mechanically connects the electrical part to the electronic control device and forms a socket around the contact strip.

As already explained with reference to the electrical component according to the invention, a particularly simple production method comprising few production steps is created in this way, said production method at the same time rendering possible the mechanical connection of the individual constituent parts of the component, providing protection for the sensitive electronic parts and in so doing at the same time forming a socket for making electrical contact with the electrical component, so that a separate component for said socket can be dispensed with.

It is preferred here for a metal contact comb which is electrically conductively connected to the electronic control device to be used as the contact strip. The electrically conductive connection can be produced, for example, by soldering, crimping, press-welding or the like here.

Therefore, particularly stable electrical contact is ensured between the component and external parts, said contact even remaining stable under the challenging operating conditions in a motor vehicle.

In a further preferred embodiment of the invention, the contact strip is partially encapsulated by injection molding with a main body composed of plastic, in particular a thermoplastic, before connection to the electronic control device.

This provides the contact strip with additional mechanical stability. During encapsulation of the electronic control device by injection molding, the main body can further be connected to the plastic which is used in this injection molding step, and therefore the mechanical stability is additionally improved.

It is further preferred for the control device to be encapsulated by injection molding such that the plastic completely encapsulates the control device.

As a result, a complete housing is provided for the control device in one single method step, which housing can reliably protect said control device against environmental influences.

It is further preferred for an electric motor, in particular an electric actuating motor for a motor vehicle, to be used as the electrical part.

Secure encapsulation of the electronic control device is particularly advantageous specifically in the case of parts such as electric motors since they are often exposed to particularly high loads.

It is further preferred for the socket to be formed as a socket for a bus system, in particular for a CAN or LIN bus.

As already explained, a standardized contact-connection for the electrical component is created in this way, and therefore said electrical component can be used in a large number of different motor vehicles without problems.

It is further preferred for a thermoset to be used as the plastic.

Thermosets are mechanically and thermally particularly stable, and therefore the electrical component is particularly well protected.

The invention and embodiments thereof will be explained in more detail below with reference to the drawing,

in which:

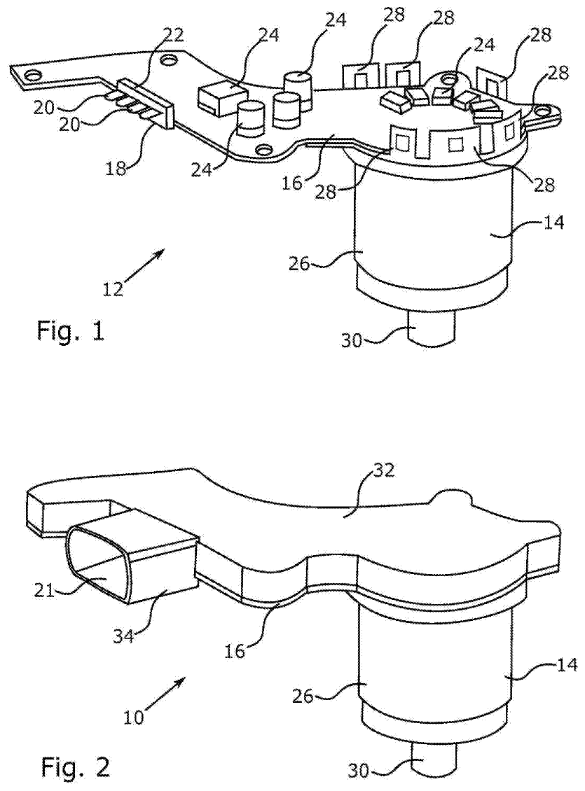

FIG. 1 shows a preassembled arrangement comprising an electric actuating motor, a printed circuit board of an electronic control device and a contact strip for it before the encapsulation by injection molding; and

FIG. 2 shows the exemplary embodiment of an electrical component according to the invention obtained by partially encapsulating the arrangement from FIG. 1 by injection molding.

In order to manufacture an actuating motor unit, illustrated in FIG. 2 and designated 10 overall, with an integrated control device, the preassembly arrangement, illustrated in FIG. 1 and designated 12 overall, is initially provided. To this end, an electric motor 14 is fitted to a printed circuit board 16 of the electronic control device. A contact strip 18, which later forms the electrical contacts for a socket 21, is further mounted onto the printed circuit board 16.

The contact strip 18 has a plurality of electrical contacts 20 which are not all designated for reasons of clarity and which are held in a main body 22 composed of plastic. Said main body can be manufactured by injection molding onto the electrical contacts 20 of the contact strip 18, preferably composed of a thermoplastic.

Customary connection methods, such as soldering, crimping or the like for example, can be used for connecting the contact strip 18 to the printed circuit board 16. Furthermore, electronic parts 24, which are likewise not all designated for reasons of clarity and which provide the functions for controlling the motor 14, are premounted on the printed circuit board 16.

A housing 26 of the motor 14 has a large number of axially protruding lugs 28 which are arranged opposite an output drive 30 of the motor 14 and engage around the printed circuit board 16 in its region of contact with the motor and in this way hold said printed circuit board in the preassembly arrangement 12 shown.

The preassembly arrangement 12 is consequently inserted into an injection molding die and encapsulated by injection molding with a plastic body 32 in regions. Said plastic body preferably consists of a thermoset which can particularly readily meet the mechanical requirements to which the actuating motor 16 is subject during operation. The plastic body 32 completely encapsulates the printed circuit board 16, and therefore the electronic parts 24 and also the printed conductor tracks of the printed circuit board 16 are protected. At the same time, the plastic body 32 surrounds the lugs 28 of the housing 26 of the motor 14, and therefore a fixed mechanical connection is created between the printed circuit board 16 and the motor 14.

During the injection molding of the plastic body 32, the sleeve 34 of the socket 21 is formed around the contact strip 18 at the same time, and therefore the prefabrication of a separate socket can be dispensed with. In this case, the injection-molded plastic can be connected to the main body 22 of the contact strip 18, so that no holes or gaps through which moisture could subsequently enter the plastic body 32 remain.

This results in a particularly stable and at the same time easy-to-manufacture actuating motor unit 10 which can be used, for example, as a clutch actuator or gear selector in an automatic transmission of a motor vehicle.

1-14. (canceled)

15. An electrical component for a motor vehicle, comprising:
an electrical part;
an electronic control device having a contact strip; and
an injection molding which forms a socket around the contact strip and at least partially encapsulates the control device and the electrical part to form a mechanical connection thereof, wherein the injection molding is plastic.

16. The electrical component as claimed in claim 15, wherein the contact strip is a metal contact comb.

17. The electrical component as claimed in claim 16, wherein the contact strip has a main body composed of a plastic.

18. The electrical component as claimed in claim 15, wherein the plastic completely encapsulates the electronic control device.

19. The electrical component as claimed in claim 15, wherein the electrical part is embodied as an electric motor,

20. The electrical component as claimed in claim 19, wherein the electrical part is an electric actuating motor for a motor vehicle.

21. The electrical component as claimed in claim 15, wherein the socket is a socket for a bus system.

22. The electrical component as claimed in claim 21, wherein, the bus is a CAN or LIN bus.

23. The electrical component as claimed in claim 15, wherein the plastic is a thermoset.

24. A method for producing an electrical component comprising:
inserting into an injection molding die a contact strip, an electrical part and an electronic control device; and
injection molding with a plastic to at least partially encapsulate the control device and the electrical part which mechanically connects the electrical part to the electronic control device and forms a socket around the contact strip thereby preassembling a contact strip and an electrical part with an electronic control device.

25. The method as claimed in claim 24, wherein preassembling the contract strip further comprises electrically conductively connecting a metal contact comb to the electronic control device as the contact strip.

26. The method as claimed in claim 24, wherein partially encapsulating by injection molding further comprises the contact strip having a main body composed of a plastic before connection to the electronic control device.

27. The method as claimed in claim 26, wherein the plastic is a thermoplastic.

28. The method as claimed in claim 24, wherein the control device s encapsulated by injection molding such that the plastic completely encapsulates the control device.

29. The method as claimed in claim 24, wherein the electrical part is an electric motor for a motor vehicle.

30. The method as claimed in claim 29, wherein 5 the electrical part is an electric actuating motor.

31. The method as claimed in claim 24, wherein the socket is for a bus system.

32. The method as claimed in claim 31, wherein, the bus system is a CAN or LIN bus.

33. The method as claimed in claim 24, wherein a thermoset is used as the plastic.
